(19) United States
(12) Patent Application Publication
(10) Pub. No.: US 2010/0110008 A1
(43) Pub. Date: May 6, 2010

(54) LIGHTED CURSOR CONTROL STICK AND CAP

(76) Inventor: Mark R. Slotta, Portage, MI (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/262,270

(22) Filed: Oct. 31, 2008

(51) Int. Cl. G09G 5/08; H01H 13/70

(52) U.S. Cl. 345/161; 345/170

(57) ABSTRACT

A lighted input device includes a cursor control stick and cap with an engagement surface disposed on an axial end face of the cursor control stick and cap. An indicating portion is located on the same axial end face as the engagement surface. A light permeable portion is provided on the cursor control stick and cap and is made of one of transparent and translucent material. A light source is configured to provide light into the light permeable portion and through the indicating portion.

### BACKGROUND OF THE INVENTION

This invention relates in general to a computer-input device and in particular to a cursor-pointing device (cursor control stick), of a notebook-type portable computer, cellular phone, personal digital assistant, or similar device. A finger mouse or cursor control stick, as used in this application, is a man-machine interface device, which controls the motion of a computer display cursor or other electronic position or selection indication. In particular, a control stick is a type of miniature joystick, which is intended to be operated by the tip of one finger of the user.

Typically, a control stick is mounted in a central location on a computer keyboard, such as between the “G”, “H” and “B” keys on a standard “QWERTY”-type keyboard. The control stick has a position sensing mechanism, which detects horizontal pressure in any horizontal direction. The cursor moves in a direction that corresponds to the direction of pressure exerted on the control stick and, in some embodiments, at a speed that corresponds to the amount of pressure exerted on the control stick. The control stick includes an elongated shaft. The shaft of the control stick has a small diameter, thus allowing the control stick to be mounted between the keys of the computer keyboard without causing the placement of the keys to vary greatly from that expected by an experienced user. A cap is typically removably mounted on the upper end of the control stick shaft, in order to provide an enlarged contact surface for a user to press against on the small diameter shaft of the control stick.

### SUMMARY OF THE INVENTION

This invention relates to a lighted input device that includes a cursor control stick and cap with an engagement surface disposed on an axial end face of the cursor control stick and cap. An indicating portion is located on the same axial end face as the engagement surface. A light permeable portion is provided on the cursor control stick and cap and is made of one of transparent and translucent material. A light source is configured to provide light into the light permeable portion and through the indicating portion.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a typical portable computer employing a lighted cursor control stick and cap in accordance with this invention.

FIG. 2 is a side view, partly in section, of the cursor control stick illustrated in FIG. 1.

FIG. 3 is a cross-sectional view illustrating an embodiment of a cushioned cap mounted on a cursor control stick of a computer keyboard, the cursor control stick having an LED light for internally illuminating the cushioned cap.

FIG. 4 is a top plan view of an alternate embodiment of a cushioned cap.

FIG. 5 is a cross-sectional view of the cushioned cap illustrated in FIG. 4, taken along the line 5-5, together with a cursor control stick upon which the cushioned cap is mounted, the cursor control stick having an LED light for internally illuminating the cushioned cap.

FIG. 6 is a cross-sectional view of a cursor control stick and cap and a plurality of lights configured to illuminate the cap.

FIG. 7 is a cross-sectional view of a light-transmitting cursor control stick and a plurality of lights configured to illuminate the cursor control stick.

FIG. 8 is a cross-sectional view of a light-transmitting cursor control stick and a light configured to illuminate the cursor control stick.

FIG. 9 is a cross-sectional view of a light source and a fiber optic cable configured to illuminate a cap on a cursor control stick.

FIG. 10 is a cross-sectional view of a lighted cursor control stick without a separate cap.

### DETAILED DESCRIPTION OF THE PREFERRED EMBODIMENT

Preliminarily, it should be noted that certain terms used herein, such as “upper”, “lower”, “top”, “bottom”, “and “side”, and words of like import are used to facilitate the description of the various embodiments of the invention. Unless otherwise specified or made apparent by the context of the discussion, such terms should be interpreted with reference to the figure under discussion. Such terms are not intended as a limitation on the position in which the assembled components of the invention may be used, but merely to define a common frame of reference for the description of the orientation of components one to another. Indeed, it is contemplated that in some embodiments, the assembled components of the invention may be easily hand-held in any desired orientation for use.

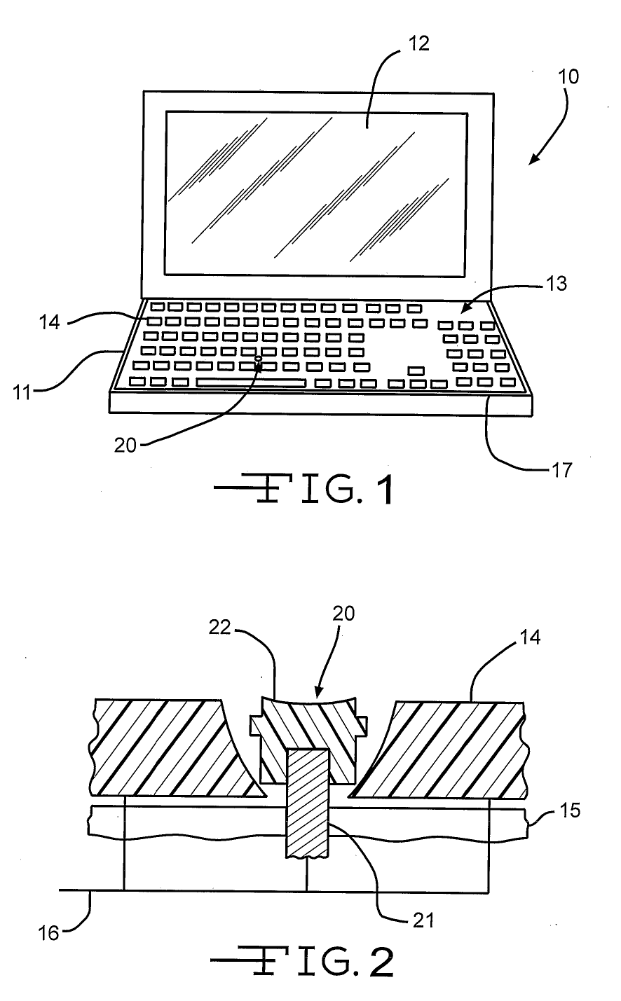

Referring now to FIGS. 1 and 2, there is illustrated a laptop computer, indicated generally at 10, including a lighted cursor control stick and cap 20 in accordance with the invention. The illustrated computer 10 includes a housing 11 and a monitor or display 12. The computer 10 includes a keyboard assembly, indicated generally at 13. The keyboard assembly 13 includes a plurality of keys 14 and a base 15 having corresponding switches (not shown) and logic circuitry, shown schematically at 16. The keyboard assembly 13 may further include a communications cable (not shown) to communicably connect the circuitry 16 to the computer 10. The keyboard assembly 13 further includes a bezel 17 to facilitate placement and/or attachment of the assembly 13 within the housing 11 of the computer 10, although such is not required. The keyboard assembly 13 further includes the lighted cursor control stick and cap 20, in accordance with the invention. The keyboard assembly 13 may further include other input devices (not shown) that facilitate the collection of input from a user in conjunction with or as an alternative to the lighted cursor control stick and cap 20. For example, the keyboard assembly 13 may include a touch pad (not shown) in addition to the lighted cursor control stick and cap 20 and a user may be able to use the lighted cursor control stick and cap 20 and the touch pad as input devices to the computer 10 simultaneously or alternatively.

The illustrated embodiment includes a cursor control stick 21 and a cap 22. The cursor control stick 21 is mounted at a first end (not shown) to the computer 10, between the keys 14 of the keyboard assembly 13. The cap 22 is removably mounted on the second end of the cursor control stick 21. The cursor control stick 21 is usually made of a plastic or metal material, and translates the force on the cap 22 into a command to move a cursor on a video display 12 of the computer 10.

It will be appreciated that the lighted cursor control stick and cap 20 may be mounted to any electronic device, including but not limited to desktop computers, laptop computers, personal digital assistants, portable playback devices such as MP3 players, portable media players such as the iPod® brand players marketed by Apple, Inc. of Cupertino, Calif., satellite radio receivers, voice recorders, cellular phones, cordless phones, inventory, freight, and parcel tracking handheld devices, and vehicular control consoles. The cursor control stick 21 may be provided in combination with any other input devices such as keyboards and/or touch pads for an electronic device. The lighted cursor control stick and cap 20 may be used in conjunction with at least one key (not shown) that alters the input behavior of the lighted cursor control stick and cap 20 or the associated cursor function of the computer 10, such as conventional left and right mouse buttons, although such is not required. The lighted cursor control stick and cap 20 may be integrated within the housing 11 of the computer 10 or the bezel 17 of the keyboard assembly 13, although such is not required.

Control sticks and removable caps are known in the art. It should be understood that the cap 22 of this invention can be manufactured in a variety of geometries, of a variety of materials, and by a variety of methods, including those taught in my co-pending U.S. patent application Ser. No. 11/523,725, Publication Number: US 20070063974 A1, the disclosures of which are incorporated herein by reference.

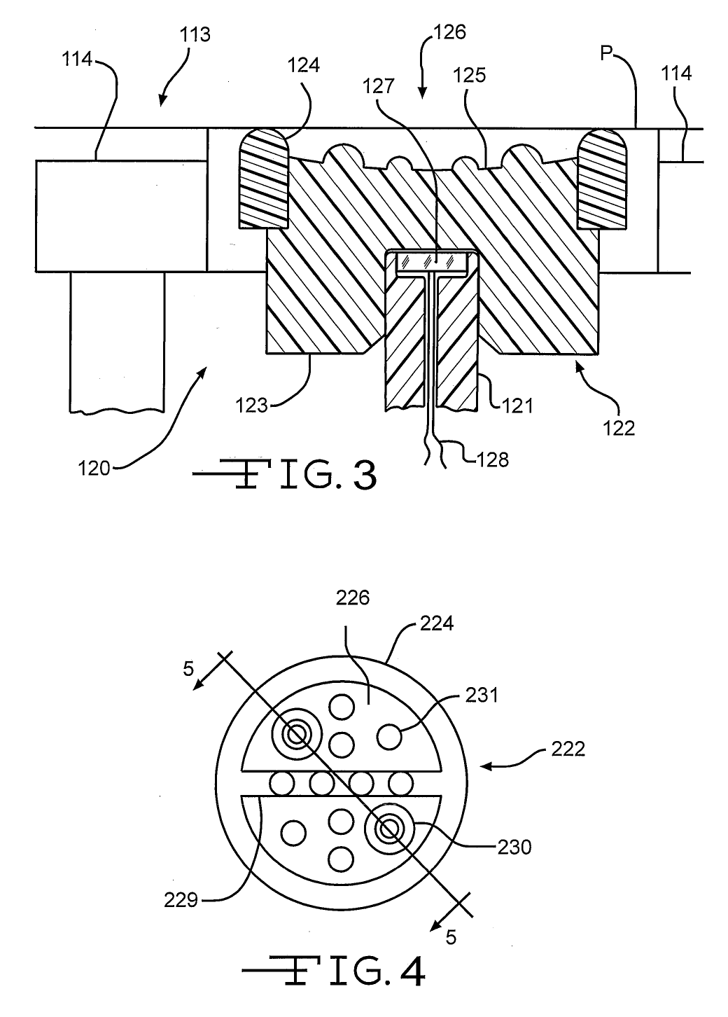

Referring now to FIGS. 3 through 9, there are illustrated various embodiments of lighted cursor control sticks and caps in accordance with the invention. Each of the illustrated embodiments includes a cushioned cap with an upper portion and a lower portion. The cushioned cap is provided to improve comfort and ease of manipulation of the cursor control stick by a user. Each of the upper portions and the lower portions may be formed of the same material or may each be formed of different materials. The upper portions and the lower portions may be integrally formed. Each of the cushioned caps may have upper portions and lower portions that have the same or different durometers than one another when cured. The cushioned caps may be formed of any suitable material. Examples of some materials that may be suitable for the upper portion and lower portion of the cushioned caps illustrated in FIGS. 3 through 9 include (without excluding other materials) thermoplastic elastomer, thermoplastic elastomer olefin, thermoplastic elastomer polyolefin, Santoprene®, styrene maleic anhydride, Dylark®, polycarbonate, polypropylene, acrylonitrile butadiene styrene (ABS), polycarbonate acrylonitrile butadiene styrene, styrene maleic anhydride (SMA), polyphenylene oxide (PPO), nylon, polyester, acrylic, polysulfone, thermoplastic polyether, thermoplastic urethane, polypropylene, polyurethane, copolyester, thermoplastic styrenic elastomer, nylon, rubber, nitrile butadiene rubber (NBR) and any combination thereof. Examples of materials such thermoplastic elastomers include the Starflex family of thermoplastic rubbers available from Star Thermoplastics and Alloys, Inc., Chicago, Ill., or DYNAflex® Thermoplastic Elastomer Compounds available from GLS Corporation, McHenry, Ill., although use of these materials is not required. The cushioned caps illustrated in FIGS. 3 through 9 may also be formed of material with any suitable color (including decorative effects such as pearlescents, metallics, glowing, swirls, or sparkles), translucence, opacity or clarity, and with any suitable surface texturing (either from the formations of surface effects such as bumps, nubs, rings, etc, as described above, or through innate slickness or tackiness of the surface feel of the material used to form the cushioned caps), or any desired degree of upper surface concavity or convexity. Elastomers having high, medium or low durometers may be blended with each other, blended or treated with other materials, or physically modified in shape to render them respectively more or less flexible generally or in desired localized areas.

Referring now to FIG. 2, the cushioned cap 22 may extend from the control stick 21 to any desired height relative to the keys 14. For example, as illustrated in FIG. 2, when the cushioned cap 22 and keys 14 are disposed for use on the computer 10, the cushioned cap 22 extends at a height that is relatively the same as the height of the keys 14. However, it will be appreciated that the cushioned cap 22 may be configured to extend from the computer 10 at a height greater than, less than, or equal to the height of which the keys 14 extend from the computer 10. Therefore, the cushioned cap 22 may extend from the keyboard assembly 13 so that the cushioned cap 22 is taller, shorter, or the same height as the keys 14 in accordance with the invention.

Referring now to FIG. 3, a cushioned cap 122 is shown mounted on a cursor control stick 121 mounted on a keyboard 113. The keyboard 113 is provided with a plurality of keys 114 disposed about the cursor control stick 121 and the cushioned cap 122. In the illustrated embodiment, the keyboard 113 is provided with a standard “QWERTY”-type arrangement of the keys 114, with the cursor control stick 121 mounted in a central location on the keyboard 113, between the “G”, “H” and “B” keys. In the common system of typing known as touch typing, the user's fingers are kept lightly resting on a home row of keys on a keyboard when not actively keying a particular key. When touch typing, the fingers of the left hand rest on the “A”, “S”, “D”, and “F” keys, and the fingers of the right hand rest on the “J”, “K”, “L” and “;” keys. The “G” and “H” keys are also on the home row, between the “F” and “J” keys.

The keys 114 are typically provided with graphics, indicating what letter, number or symbol will appear when the key is manipulated, but such graphics may not be visible when using the keyboard 113 in low light conditions. Some keyboards are provided with tactile cues to alert the users to contact with certain keys. For example, on the LATITUDE® D820 laptop computer manufactured by Dell Inc. of Round Rock, Tex., the “F” and the “J” keys are provided with a small raised ridge on the upper surfaces thereof, near the edge most proximate to a user. This can assist the user in identifying the keys on which to rest their index fingers when positioning their hands on the home row of the keyboard. However, through use, these raised ridges can wear down. Additionally, some users do not hold their fingers in a manner that causes their fingers to contact these raised ridges, which are quite near the proximal edges of these keys. Thus, the location of the cursor control stick 121 between the “G” and “H” keys can serve as a visual cue for where users are to rest their fingers, with their index fingers resting one key outwardly from the cushioned cap 122 on the cursor control stick 121, i.e., about one finger's width from the cushioned cap 122.

The lighted cursor control stick and cap 120 provides a device for visually indicating a reference location on a keyboard in low light conditions. As seen in FIG. 3, the cursor control stick 121 is provided, at an upper end thereof, a light source 127. The light source 127 may be of any suitable type, including an electrically operated light (such as a light emitting diode—LED, or an incandescent bulb of suitable wattage), a chemical light (such as one utilizing chemoluminescence, fluorescence, or phosphorescence), or self-powered lighting (such as a radioluminescent source). In the illustrated embodiment, the light source 127 is shown as a separate component; however, it should be appreciated that the light source 127 could comprise the material of the cursor control stick 121 or the cushioned cap 122. For instance, a photoluminescent (glow-in-the-dark) material could be used for at least one of the materials comprising the cushioned cap 122 (or the cap 22 illustrated in FIG. 2) so that an upper surface of the cap 122 (or the cap 22) is illuminated so as to be seen by a user. In the embodiment illustrated in FIG. 3, an LED is utilized as the light source 127. The LED comprising the light source 127 is electrically connected to a source of electrical power (not shown) via wires 128, which may suitably be routed through a passageway in the cursor control stick 121.

The lower portion 123 of the cushioned cap 122 is formed of a translucent or transparent material, or may be provided with one or more bores or opening (not shown), so that light from the light source 127 can shine out of an upper surface 125 of the lower portion 123 to be seen by a user. The upper portion 124 may also be formed of translucent or transparent material, or provided with one or more bores (not shown), so that light may shine through the lower portion 123 and then through the upper portion 124 to be seen by a user. The upper portion 124 and the lower portion 123 maybe of different transparent colors to provide a decorative effect. The upper portion 124 may also be opaque. The portion of the cushioned cap 122 through which light passes to be seen by a user constitutes an indicating portion, indicated generally at 126, of the cushioned cap 122. It should be appreciated that the size and shape of the indicating portion 126 will depend on the light-transmitting characteristics of the lower portion 123 and the upper portion 124.

The upper surface 125 of the cap 122 is also the engagement surface of the cursor control stick and cap 120. That is, the upper surface 125 is disposed for engagement by the user's finger when the lighted cursor control stick and cap 120 is operated by the tip of one finger of the user. It will be appreciated that the upper surface 125 is located on an axial end face of the elongate lighted cursor control stick and cap 120. In the illustrated embodiment, the indicating portion 126 is part of the upper surface 125. Consequently, light from the light source 127 will travel through the indicating portion 126 and be directly visible to a person situated to operate the cursor control stick and cap 120, and allow the person to see where to place their finger to operate the cursor control stick and cap 120 (until, of course, the person places his or her finger onto the engagement surface and partially or completely obscures the indicating portion 126—by which time the user will already know where his or her finger is located).

In use during low light conditions, the user will be able to see the light from the light source 127 emitted through the indicating portion 126 of the cushioned cap 122, and thus be provided a visual cue as to where to place his fingers to engage the desired keys on the keyboard 113. The cushioned cap 122 thus serves as a reference location amid the keys 114. The light source 127 and the indicating portion 126 constitute an indicator for visually indicating a reference location on the keyboard 113.

As indicated in FIG. 3, the operating (upper) surfaces of the keys 114 are supported within a plane P when not being pressed by a user. The keys 114 are substantially located on a first side of the plane P, that is, below the plane P as viewed in FIG. 3. The embodiment of the cushioned cap 122, similarly, is preferably substantially located on the first side of the plane P, with no portion of the cushioned cap extending more than about 5 millimeters on a second side of the plane P, to avoid interfering with the movement of a user's fingers during use of the keyboard 113. The indications of measurements herein are general indications of dimensions. These general indications of dimensions are provided for reference only and are not intended to limit the invention to such dimensions. It will be appreciated that the various embodiments of the lighted cursor control stick and cap of the invention may be practiced in any size with the elements thereof having any relative dimension to one another.

As discussed above, the lower portion 123 and the upper portion 124 of the cushioned cap 122 may be provided with one or more bores (not shown), so that light from the light source 127 can be seen by a user. While these bores may be just openings in the material, it is also contemplated that the bores may be filled with transparent or translucent material.

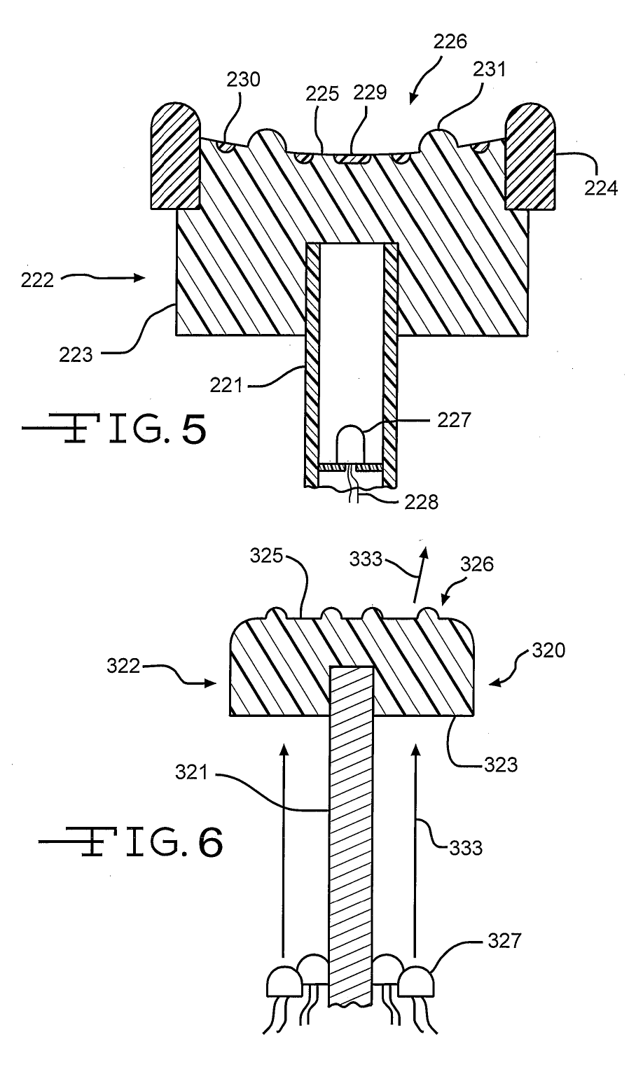

An indicating portion 126 of a cushioned cap can be used for purposes other than visually indicating a reference location on a keyboard 13. For example, refer now to FIGS. 4 and 5. A cushioned cap, indicated generally at 222 is shown provided with an indicating portion 226. The indicating portion 226 is preferably composed of a translucent or transparent material. In the illustrated embodiment, the cushioned cap 222 is composed of an opaque upper portion 224 and a translucent lower portion 223. The upper portion 224 includes elements 229 and 230 disposed on the upper surface 225 of the lower portion 223, including, for example a stripe 229 extending diametrically across the upper surface 225, and rings 230 disposed about nubs 231 formed on the upper surface 225.

A light source 227 is disposed below the lower portion 223 of the cushioned cap 222. In the illustrated embodiment, this light source 227 is a light emitting diode that is mounted on a cursor control stick 221 so as to emit light up through the translucent lower portion 223, and through the portions of the upper surface 225 that are not covered by the opaque upper portion 224. Alternatively, the light source may be provided in any other desired location relative to the cushioned cap 222 and using any other desired means. In this manner, light shining through the upper surface 225 can be caused to form a graphic design. Alternatively, the opaque material of the upper portion 224 can be said to form the graphic design. In any case, the graphic design formed by the control of light transmission through the lower portion 223 and past the upper portion 224 can be used for a variety of suitable purposes. The design could, for example display a trademark, or it could serve a decorative purpose. The light shining through the upper surface 225 of the cushioned cap 222 can produce a variety of designs based upon the properties of the lower portion 223, the upper portion 224 and the light source 227. For instance, the light-permeability of the materials used for the lower portion 223 and the upper portion 224 can be selected from materials that are transparent, translucent or transparent. Also, voids or bores can be included in the lower portion 223 and the upper portion 224 to allow the transmission of light. Further, the colors of the lower portion 223 and the upper portion 224 can be changed. A wide variety of visual appearances on the indicating portion 226 can be produced by changing these properties of the cushioned cap 222. Additionally, changing the color and intensity of the light source 227 can change the visual appearance produced on the indicating portion 226.

While the elements 229 and 230 are illustrated as being disposed in grooves formed in the lower portion 223 so that these elements 229 and 230 are flush with the surrounding surface, the elements 229 and 230 forming part of the upper portion 224 could be otherwise (i.e., stand proud of the surrounding surface, or even be recessed below the surrounding surface in even deeper grooves formed in the lower portion 223).

Referring now to FIG. 6, a cushioned cap 322 is shown mounted on an opaque cursor control stick 321 (partially illustrated). The cursor control stick 321 may be formed of any suitable material (such as steel). The cushioned cap 322 is formed of any suitable translucent or transparent material, as described above. The cushioned cap 322 has a lower surface 323, and an upper surface 325.

A light source 327, composed of one or more individual lights, is disposed adjacent the cursor control stick 321 so as to be able to shine light 333 onto the lower surface 332 of the cushioned cap 322, so that the light 333 passes through the cushioned cap 322, and will shine out of the upper surface 325 of the cushioned cap 322.

The portion of the cushioned cap 322 through which light passes to be seen by a user constitutes an indicating portion, indicated generally at 326, of the cushioned cap 322. The light source 327 and the indicating portion 326 thus can visually indicate a reference location on an associated keyboard (not shown). The lighted cursor control stick and cap 320 illustrated in FIG. 6 (or of any of the other lighted cursor control sticks and cap discussed herein) may serve additional functions as well. In one arrangement, the light source 327 may activated to emit the light 333 only in certain conditions. For example, the light source 327 may be activated to emit the light 333 as a replacement for, or as a supplement to an audible signal such as is common for computers (for example, in some versions of Microsoft Corporation's Windows® operating system, a sound can be assigned to play when a program opens or closes) when an audible signal would be inappropriate (such as when using a computer in a library, so as to not disturb other patrons) or when an audible signal would be ineffective, such as during use in a very high noise area, or if the user is deaf or hearing impaired. The light source 327 may be arranged to provide different colors of lights (for example, by activating different ones of a group of different colored lights) to provide a range of different signals. Alternatively, the light source 327 may be arranged to provide a sequence of light pulses (such as differing combinations of short and long light pulses) to provide a range of different signals. Such a visual signal function could be useful in a wide variety of situations to provide visual feedback to the user that an action has occurred, such as during troubleshooting of a computer when a video display is not working or not present, or such as pulsing and changing colors in response to music being played from a computer file on a computer (not shown) which the lighted cursor control stick and cap 320 is installed.

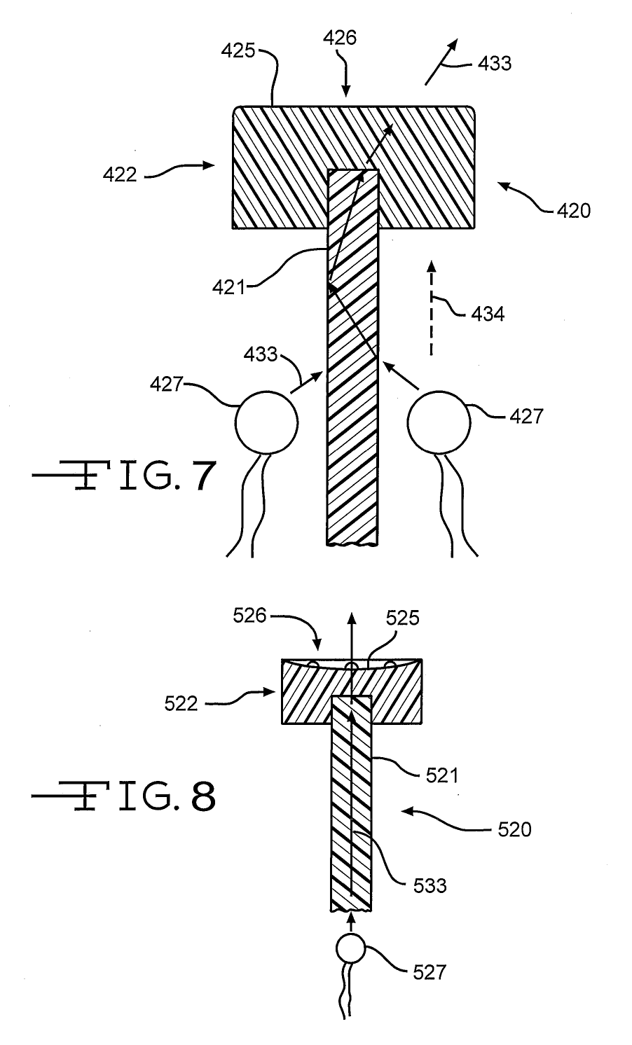

An alternate arrangement of a lighted cursor control stick and cap 420 is illustrated in FIG. 7. A cushioned cap 422 is shown mounted on a cursor control stick 421 (partially illustrated). The cursor control stick 421 may be formed of any clear or translucent material with sufficient strength, rigidity, and other material properties to act as a suitable cursor control stick in the desired application. The cushioned cap 422 is formed of any suitable translucent or transparent material, as described above. The cushioned cap 422 has an upper surface 425.

A light source 427 is disposed adjacent the cursor control stick 421 so as to be able to shine light 433 into the cursor control stick 421, through the cursor control stick 421 and thence through the cushioned cap 422, so that the light 433 will shine out of the upper surface 425 of the cushioned cap 422. As with the other embodiments of cursor control sticks described herein, the cursor control stick 421 may be provided with structures (such as faceted or rounded surfaces, flanges, bosses, etc.—all not shown) that facilitate transmission of the light 433 into and out of the cursor control stick 421. It will also be apparent that light 433 may be allowed, if desired, to also shine directly from the light source 427 to the cushioned cap 422 along a path illustrated at 434, in a manner similar to the lighted cursor control stick and cap 320 discussed above with reference to FIG. 6.

Thus, the portion of the cushioned cap 422 through which light passes to be seen by a user constitutes an indicating portion, indicated generally at 426, of the cushioned cap 422. The light source 427 and the indicating portion 426 thus can visually indicate a reference location on an associated keyboard (not shown), or provide other visual functions as described above. The light source 427, like the light source 327, can be composed of one or more individual lights, may provide a variety of colors, and may be caused to pulse, change colors, or change intensity in a fashion to provide a variety of indications.

An alternate arrangement of a lighted cursor control stick and cap 520 is illustrated in FIG. 8. A cushioned cap 522 is shown mounted on a cursor control stick 521 (the length of which is illustrated, but not showing how the cursor control stick 521 is mounted to transmit movement to sensors, which is known in the art). The cursor control stick 521 may be formed of any clear or translucent material with sufficient strength, rigidity, and other material properties to act as a suitable cursor control stick in the desired application. The cushioned cap 522 is formed of any suitable translucent or transparent material, as described above. The cushioned cap 522 has an upper surface 525.

A light source 527 is disposed below the cursor control stick 521 so as to be able to shine light 533 into the cursor control stick 521, along the length of the cursor control stick 521 and thence through the cushioned cap 522, so that the light 533 will shine out of the upper surface 525 of the cushioned cap 522.

Thus, the portion of the cushioned cap 522 through which light passes to be seen by a user constitutes an indicating portion, indicated generally at 526, of the cushioned cap 522. The light source 527 and the indicating portion 526 thus can visually indicate a reference location on an associated keyboard (not shown), or provide other visual functions as described above. The light source 527, like the light source 327, can be composed of one or more individual lights, may provide a variety of colors, and may be caused to pulse, change color, or change intensity in a fashion to provide a variety of indications.

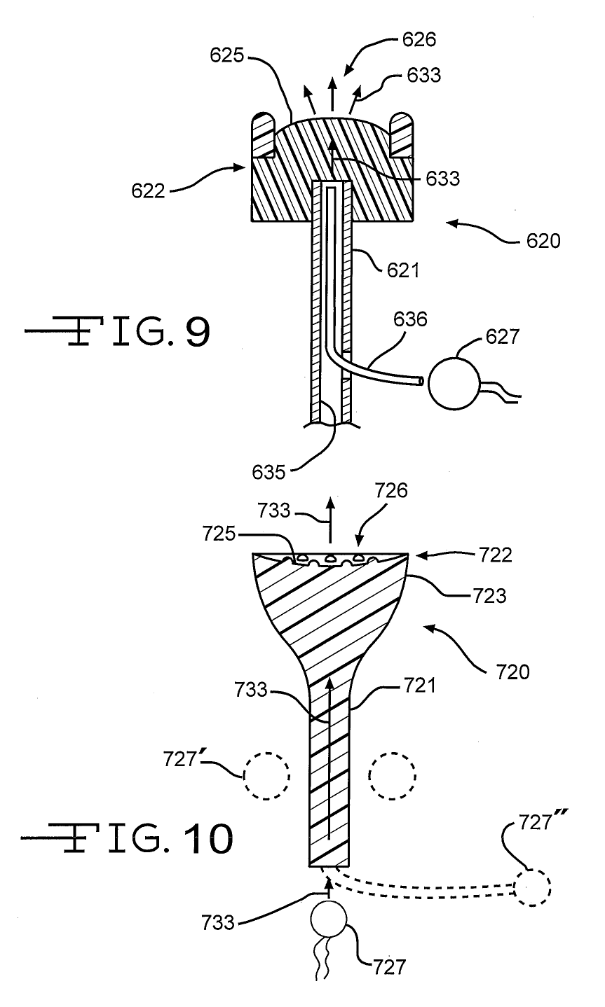

An alternate arrangement of a lighted cursor control stick and cap 620 is illustrated in FIG. 9. A cushioned cap 622 is shown mounted on a cursor control stick 621 (partially illustrated). The cursor control stick 621 may be formed of any material with sufficient strength, rigidity, and other material properties to act as a suitable cursor control stick in the desired application. The cursor control stick may be made of an opaque material, such as steel. The cursor control stick 621 defines a longitudinal passageway 635 therein. The cushioned cap 622 is formed of any suitable translucent or transparent material, as described above. The cushioned cap 622 has an upper surface 625.

A fiber optic cable 636, composed of one or more optical fibers, is operatively routed between a light source 627 and the cushioned cap 622 so as to be able to transmit light 633 from the light source 627 into the cushioned cap 622. The light 633 then travels through the cushioned cap 622, so that the light 633 will shine out of the upper surface 625 of the cushioned cap 622.

Thus, the portion of the cushioned cap 622 through which light passes to be seen by a user constitutes an indicating portion, indicated generally at 626, of the cushioned cap 622. The light source 627, the fiber optic cable 636, and the indicating portion 626 thus can visually indicate a reference location on an associated keyboard (not shown), or provide other visual functions as described above. The light source 627, like the light source 327, can be composed of one or more individual lights, may provide a variety of colors, and may be caused to pulse, change color, or change intensity in a fashion to provide a variety of indications.

An alternate arrangement of a lighted cursor control stick and cap 720 is illustrated in FIG. 10. Although in most instances it is believed that the use of a cushioned cap, such as has been described in previous embodiments, would be desirable, it is contemplated that in some applications a cushioned cap might not be provided. It is contemplated that a cap at the top of a cursor control stick might not be “cushioned” but rather may be relatively hard and non-pliant. Accordingly, the presence of the modifier “cushioned” with the word “cap” in the embodiments above should not be taken as a limitation on the scope of the invention with respect to the type of cap which may be utilized.

Indeed, the lighted cursor control stick and cap 720 is shown as one possible embodiment of the invention which does not have a removable cap at all. The lighted cursor control stick and cap 720 includes a cursor control stick 721 (the length of which is illustrated, but without showing how the cursor control stick 721 is mounted to transmit movement to sensors, which is known in the art). The cursor control stick 721 may be formed of any clear or translucent material with sufficient strength, rigidity, and other material properties to act as a suitable cursor control stick in the desired application. The cursor control stick 721 has an upper portion 723, which may be considered as an integrally formed cap of the lighted cursor and control stick and cap 720, as the upper portion 723 has an upper surface 725 which is to be manipulated by a user. The upper surface 725 may be flat, convex or concave, and may be provided with surface texturing to improve usability, such as stippling, nubs, ridges, grooves, or other surface features, which surface texturing may be of uniform height or of non-uniform height. Preferably, the upper portion 723 is provided with an enlarged diameter compared with other portions of the cursor control stick 721, as seen in FIG. 10, in order to improve comfort and ease of manipulation, though the upper portion 723 need not have an enlarged diameter, and if provided with an enlarged diameter, the shape of the upper portion 723 may suitably be different than shown.

A light source 727 is provided to shine light 733 into the cursor control stick 721, along the length of the cursor control stick 721 and thence out of the upper surface 725 of the cursor control stick 721. The light source 727 may be disposed below the cursor control stick 721 as illustrated, or may, similar to embodiments described above, be disposed adjacent the cursor control stick 721 as shown in phantom at 727′, or operatively coupled via a fiber optic cable to the cursor control stick 721 from a remote location as shown in phantom at 727″. As with the other embodiments of cursor control sticks described herein, the cursor control stick 721 may be provided with structures (not shown) that facilitate transmission of the light 733 into and out of the cursor control stick 721.

Thus, the upper portion of the cursor control stick 721 through which light passes to be seen by a user constitutes an indicating portion, indicated generally at 726, of the cursor control stick 721. The light source 727 and the indicating portion 726 thus can visually indicate a reference location on an associated keyboard (not shown), or provide other visual functions as described above. The light source 727, like the light source 327, can be composed of one or more individual lights, may provide a variety of colors, and may be caused to pulse, change color, or change in intensity in a fashion to provide a variety of indications. In the illustrated embodiment, the indicating portion 726 is part of the upper surface 725. The upper surface 725 of the cap 722 is also the engagement surface of lighted cursor control stick and cap 720. That is, upper surface 725 is disposed for engagement by the user's finger when the lighted cursor control stick and cap 720 is operated by the tip of one finger of the user.

It will be appreciated that any combination of the elements of the embodiments described herein may be combined and practiced together in accordance with the invention. It will be appreciated that the durometer of the material, the shape as described herein, and the surface shape and texture of the cushioned caps contribute to the overall feel of the cushioned caps.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A lighted input device comprising,
a cursor control stick and cap, the cursor control stick and cap comprising an elongated structure having at least one axial end face;
an engagement surface, the engagement surface disposed on an axial end face of the cursor control stick and cap;
an indicating portion, the indicating portion located on the same axial end face as the engagement surface;
a light source, the light source configured to illuminate the indicating portion.

2. The lighted input device of claim 1, further including a keyboard comprising
a framework,
a plurality of keys supported on the framework, each of the keys having a respective operating surface meant to be pressed by a user, the operating surfaces of the keys generally being supported within a plane when not being pressed by a user, the keys being substantially located on a first side of the plane;
wherein the lighted input device is substantially located on the first side of the plane and is disposed in a reference location amid said keys.

3. The lighted input device of claim 1, wherein the cursor control stick and cap includes a light permeable portion made of one of transparent and translucent material; and
the light source is configured to provide light into the light permeable portion and through the indicating portion.

4. The lighted input device of claim 3, wherein the light from the light source produces a visible design on the indicating surface.

5. The lighted input device of claim 4, wherein the light permeable portion includes components having different light permeability, wherein the light from the light source passing through the light permeable portion creates the visible design.

6. The lighted input device of claim 4, wherein the light permeable portion includes components having different colors, wherein the light from the light source passing through the light permeable portion creates the visible design.

7. The lighted input device of claim 3, wherein the cursor control stick and cap is comprised of a cursor control stick and a cap removably attached to the axial end on which the engagement surface is disposed and wherein the indicating portion is located on the removable cap.

8. The lighted input device of claim 7, wherein the light permeable portion is disposed within the removable cap.

9. The lighted input device of claim 8, wherein the cursor control stick defines a space and the light source is located within the space defined by the cursor control stick.

10. The lighted input device of claim 8, wherein the light source is comprised of at least one individual light disposed adjacent to the cursor control stick.

11. The lighted input device of claim 7, wherein the light permeable portion is disposed within the cursor control stick and within the removable cap.

12. The lighted input device of claim 11, wherein the light source is disposed so as to provide light to the light permeable portion of the cursor control stick.

13. The lighted input device of claim 12, wherein the removable cap is disposed so that the light permeable portion of the cursor control stick provides light from the light source to the light permeable portion of the removable cap, and produces a visible design on the indicating portion.

14. The lighted input device of claim 13, wherein the light source is disposed substantially below the cursor control stick.

15. The lighted input device of claim 13, wherein the light source is disposed substantially adjacent to the cursor control stick.

16. The lighted input device of claim 3, wherein the cursor control stick and cap is operatively connected to an electronic device.

17. The lighted input device of claim 16, wherein the light source is capable of different output, and the output of the light source is selectively changed in response to signals from the electronic device.

18. The lighted input device of claim 17, wherein the output of the light source is changed in response to a signal from the electronic device specifying an audible output.

19. The lighted input device of claim 17, wherein the output of the light source is caused to pulse in patterns representative of signals from the electronic device.

20. The lighted input device of claim 17, wherein the different output of the light source comprises a plurality of colors.

21. The lighted input device of claim 20, wherein the color of the light from the light source will change in response to different signals from the electronic device.

22. The lighted input device of claim 3, wherein the cursor control stick and cap is comprised of a cursor control stick with an integrally formed cap and wherein the indicating portion is located on the cap.

23. The lighted input device of claim 1, wherein the light source is a material comprising the cursor control stick and cap.

24. A keyboard including a device for visually indicating a reference location on the keyboard, comprising:
a framework;
a plurality of keys supported on said framework, each of said keys having a respective operating surface meant to be pressed by a user, said operating surfaces of said keys generally being supported within a plane when not being pressed by a user, said keys being substantially located on a first side of said plane; and
an indicator comprising:
a body which is substantially located on said first side of said plane and disposed in a reference location amid said keys, said body having an indicating portion which is one of clear, translucent, and provided with a bore; and
a light source disposed to shine light through said indicating portion of said body.

25. The keyboard according to claim 24, wherein said body is a cushioned cap disposed on a cursor control stick.
